(19) United States
(12) Patent Application Publication
(10) Pub. No.: US 2018/0339645 A1
(43) Pub. Date: Nov. 29, 2018

(54) AUTOMATIC ADAPTIVE HEADLIGHT CONTROL

(71) Applicant: Faraday&Future Inc., Gardena, CA (US)

(72) Inventors: Luke Michael Ekkizogloy, Mountain View, CA (US); Sethu Hareesh Kolluru, Fremont, CA (US); Michael Lambertus Hubertus Brouwer, Los Gatos, CA (US); Yunwei Liu, Alameda, CA (US)

(21) Appl. No.: 15/613,051

(22) Filed: Jun. 2, 2017

Related U.S. Application Data
(60) Provisional application No. 62/345,616, filed on Jun. 3, 2016.

(51) Int. Cl. B60Q 1/08; F21S 41/00

(52) U.S. Cl. CPC B60Q 1/08; F21S 41/00

(57) ABSTRACT

Systems and methods for automatic adaptive headlight control in a vehicle are disclosed. The systems and methods can detect one or more conditions, such as presence of a nearby object and/or poor visibility. The headlight can account for the one or more conditions by dynamically and automatically adjusting the total intensity of light output from the headlight, creating one or more different patterns of intensity of light, emitting different colors of light, or a combination thereof. In some examples, the headlight can include a plurality of independently controlled light emitters or a liquid crystal element. In some examples, one or more currents and/or duty cycle values can be adjusted. In some examples, the headlight can be divided into a plurality of sections, such that each section can emit different wavelengths (e.g., colors) of light.

### CROSS-REFERENCE TO RELATED APPLICATIONS

This application claims the benefit of U.S. Provisional Application No. 62/345,616, filed Jun. 3, 2016, the entirety of which is hereby incorporated by reference.

### FIELD OF THE DISCLOSURE

This relates generally to automatic adaptive headlight control for a vehicle, and more particularly, to a headlight capable of dynamic and automatic adjustment responsive to one or more detected conditions.

### BACKGROUND OF THE DISCLOSURE

Vehicles, especially automobiles, increasingly include various sensors for detecting and gathering information about the vehicles' surroundings. Autonomous vehicles can use such information for performing autonomous driving operations. However, existing autonomous driving solutions are limited in their ability to comprehensively and effectively address and optimize for various conditions encountered by the vehicles in their surroundings.

### SUMMARY OF THE DISCLOSURE

Examples of the disclosure are directed to automatic adaptive headlight control for a vehicle. The system can detect one or more conditions, such as presence of a nearby object and/or poor visibility. The headlight can account for the one or more conditions by dynamically and automatically adjusting the total intensity of light output from the headlight, creating one or more different patterns of intensity of light, emitting different colors of light, or a combination thereof.

### BRIEF DESCRIPTION OF THE DRAWINGS

FIG. 1 illustrates an exemplary driving condition with one car approaching another car according to examples of the disclosure.

FIG. 2A illustrates an exemplary headlight including a plurality of light emitters according to examples of the disclosure.

FIG. 2B illustrates an exemplary method of operating the headlight including a plurality of light emitters according to examples of the disclosure

FIG. 3A illustrates an exemplary headlight including a liquid crystal element according to examples of the disclosure.

FIG. 3B illustrates an exemplary method of operating the headlight including a liquid crystal element according to examples of the disclosure.

FIGS. 4A-4B illustrate exemplary headlights including a pattern of light emission according to examples of the disclosure.

FIG. 5 illustrates an exemplary system block diagram of a vehicle control system according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Some vehicles, such as automobiles, may include various sensors for detecting and gathering information about the vehicles' surroundings. Autonomous vehicles can use such information for performing autonomous driving operations. However, existing autonomous driving solutions are limited in their ability to comprehensively and effectively address and optimize for various conditions encountered by the vehicles in their surroundings.

Examples of the disclosure are directed to automatic adaptive headlight control. The system can detect one or more conditions, such as the presence of a nearby object and/or poor visibility. The headlight can account for the one or more conditions by dynamically and/or automatically adjusting the total intensity of light output from the headlight, creating different patterns of intensity of light, emitting different colors of light, or a combination thereof.

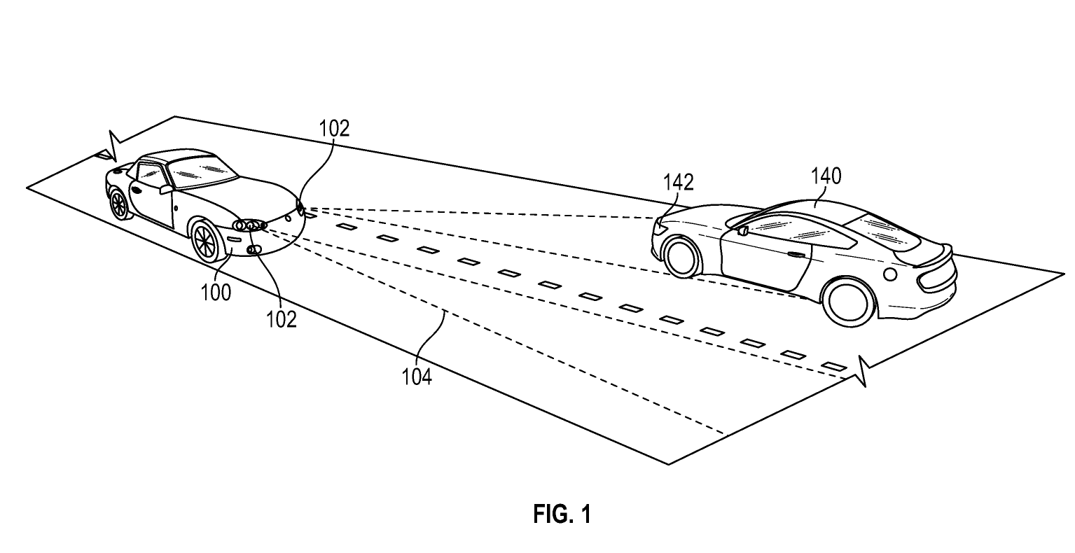

FIG. 1 illustrates exemplary driving condition with one car approaching another car according to examples of the disclosure. Vehicle 100 can be an automobile, a motorcycle, or any other vehicle that can include automatic adaptive headlights 102. Vehicle 100 can be driving in a first direction and can be approaching vehicle 140. In some examples, vehicle 140 can be driving in a second direction, opposite from the first direction. Vehicle 140 can be an automobile, a motorcycle, or another vehicle. In some examples, vehicle 140 can include headlights 142. In some examples, headlights 142 can have a plurality of modes of intensity, such as dim headbeams and high headbeams. When the user in vehicle 140 is driving, the user can switch between the plurality of modes of intensity of headlights 142 by manually turning a head beam adjustment knob (not shown). For example, when the user can be driving vehicle 140 with no other vehicles (e.g., vehicle 100) around, the user can manually switch to high (i.e., bright) head beam. When vehicle 100 approaches vehicle 140, to reduce glare seen by oncoming traffic, vehicle 140 can manually switch to dim headbeams.

In some examples, manual adjustment of the intensity of the headbeams may be cumbersome, ineffective, or both. The user may forget to switch the headbeams, or the levels of intensity may limit the user's visibility. Automatic adaptive headlights 102 can alleviate some or all of these limitations, which vehicle 100 can include. Headlights 102 can be capable of sensing the presence of one or more objects, such as vehicle 140, and automatically adjusting the overall intensity, shape, and/or size of the projected head beam 104 emitted from headbeams 102. In some examples, sensing the presence of one or more objects can include sensing visible light emitted from the object. In some examples, sensing the presence of one or more objects can include sensing the object using other detection means (e.g., infrared emissions or color contrast). While the examples of the disclosure will be described in the context of headlights 102 being capable of sensing various conditions in the surroundings of vehicle 100 (e.g., the presence of one or more objects, such as vehicle 140), it is understood that in some examples, vehicle 100, using additional or alternative sensors outside of headlights 102, can sense the various conditions in the surroundings of the vehicle. For example, vehicle 100 can utilize one or more sensors (e.g., LIDAR, radar, ultrasonic sensors, cameras, etc.) it uses for other purposes (e.g., autonomous driving operations) to control the operation of headlights 102, as described herein.

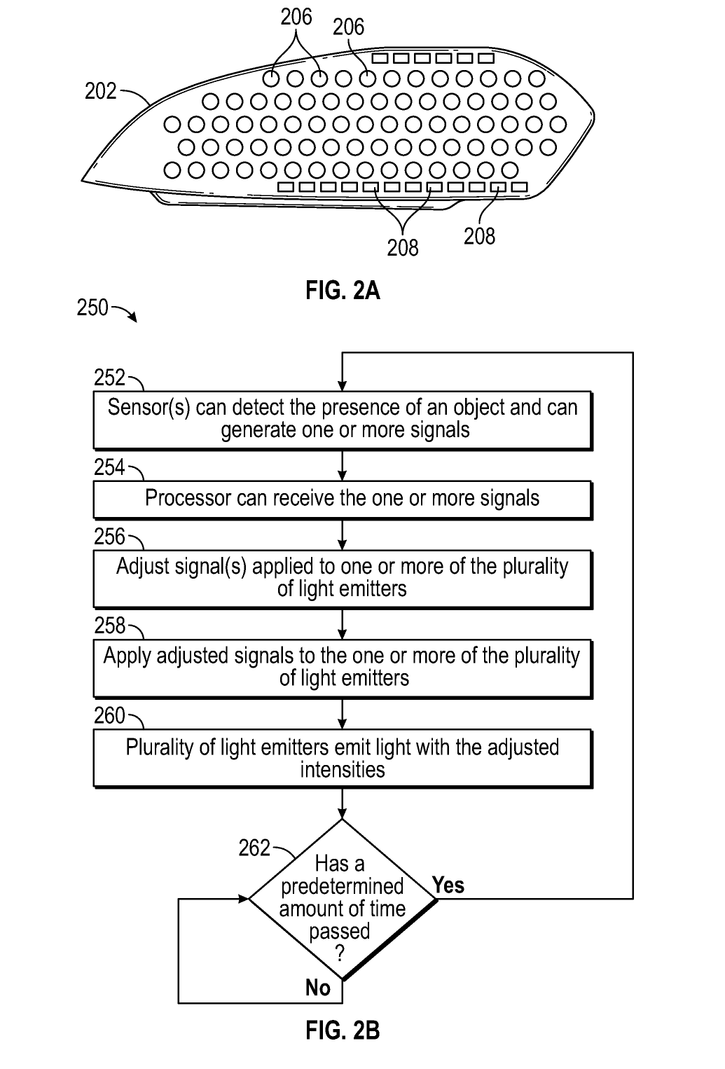

FIG. 2A illustrates an exemplary headlight including a plurality of light emitters, and FIG. 2B illustrates an exemplary method of operating the headlight according to examples of the disclosure. Headlight 202 can include a plurality of light emitters 206. Light emitters 206 can be configured to emit light in response to one or more signals, and each light emitter can be capable of being controlled independently from the other light emitters. Headlight 202 can further include one or more sensors 208. Sensors 208 can be configured to detect the presence of one or more objects and can generate a signal in response to the detected object (step 252 of process 250). Sensors 208 can be any type of sensor including, but not limited to, LIDAR, radar, ultrasonic sensors, and cameras. Sensors 208 can be capable of determining the location and/or velocity of the detected objects.

In some examples, headlight 202 can be coupled to one or more processors configured for receiving the generated signal from sensors 208 (step 254 of process 250). In response to the generated signal, the one or more processors can be configured for adjusting one or more signals applied to one or more of the plurality of light emitters 206 (step 256 of process 250). The one or more adjusted signals can be applied to plurality of light emitters 206 (step 258 of process 250). Plurality of light emitters 206 can emit light with one or more intensities based on the one or more adjusted signals (step 260 of process 250). In some examples, the process can be repeated after a predetermined time interval (step 262 of process 250). In some examples, sensors 208 can be configured to continually determine whether one or more objects are present, and the one or more signals applied to plurality of light emitters 206 may not be adjusted unless sensors 208 detect a change in sensed information. In some examples, sensors 208 can determine the velocity of the oncoming object and can adjust the intensity of light emitted by the headlights based on the velocity. For example, sensors 208 can determine that an oncoming vehicle is approaching and can gradually decrease the intensity of light as the oncoming vehicle gets closer and closer.

For example, plurality of light sensors 208 can detect lights from oncoming traffic and can generate a signal in response to the detected lights. The processor can be configured to adjust the current(s) applied to light emitters 206 based on the generated signal (e.g., lower the applied current to dim/lower the intensity of the light from light emitters 206 to prevent glare). Sensing and adjusting can be automatic and/or dynamic.

Although FIG. 2A illustrates sensors 208 located along the perimeter of headlight 202 and plurality of light emitters 206 located in the center of headlight 202, examples of the disclosure can include the sensors and the plurality of emitters located in any area of the headlight. In some examples, the sensors can be interleaved with the plurality of light emitters. In some examples, the sensors can be located on a component external from the headlight.

In some examples, plurality of light emitters 206 can be an array of light emitting diodes (LEDs). In response to one or more signals generated by sensors 208, the intensity of light emitted by one or more of the plurality of light emitters 206 can be individually adjusted (e.g., light emitters in a certain portion of headlight 202 can emit more light than light emitters in a different portion of the headlight, depending on the adjusted signals determined by the one or more processors at 256). Adjusting the intensity can include adjusting the applied current to the LEDs and/or using pulse-width modulation methods. In some examples, the adjusted intensities can include a plurality of discrete levels of intensities. In some examples, the adjusted intensity can be included in a continuum of intensities and can be related to the information detected by sensors 208. The headlight can adjust the intensity at any location or section within the headlight. For example, if the object is located closer to the center of the headlight, the center plurality of light emitters can be adjusted. In some examples, if the object is located closer to the center of the front of the vehicle (i.e., inner edges of the headlight), the plurality of light emitters located near the inner edges can be adjusted. Various circumstances in which headlight 202 can be adjusted, and the manners of such adjustments, will be described in more detail later.

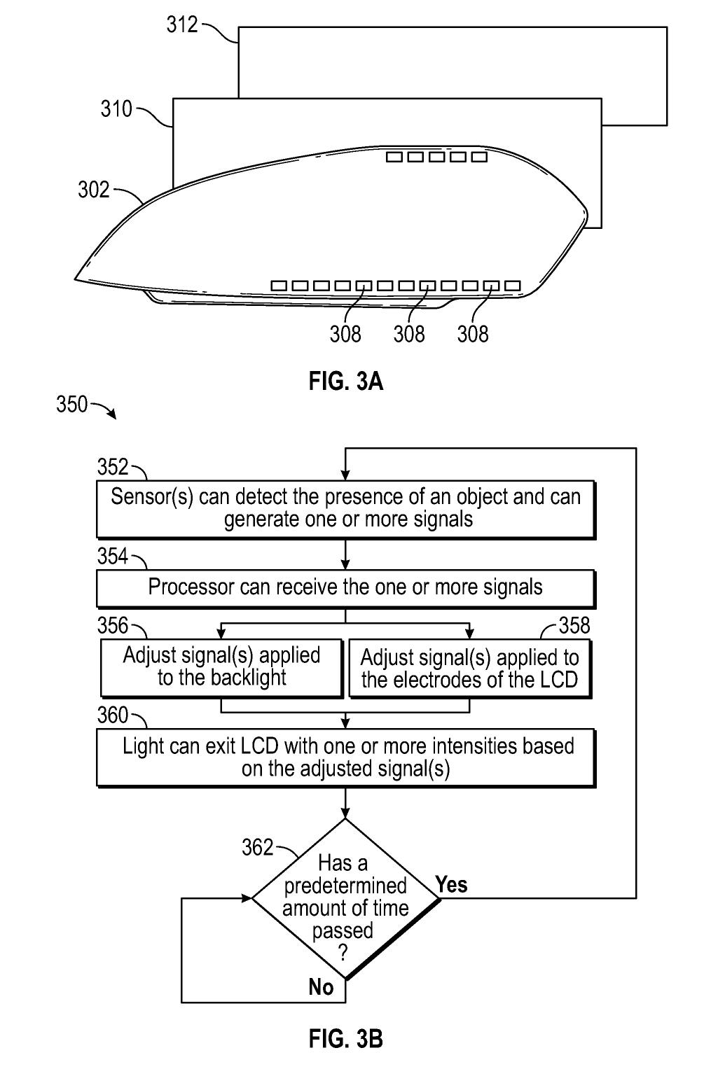

FIG. 3A illustrates an exemplary headlight including a liquid crystal element, and FIG. 3B illustrates an exemplary method of operating the headlight according to examples of the disclosure. Headlight 302 can include a liquid crystal element 310 and a backlight 312. Liquid crystal element 310 can be any type of shutter configured to allow light to transmit through. In some examples, the shutter can be a mechanical or an optical shutter. The intensity of light allowed to transmit through can depend on the voltage difference applied to a pair of electrodes. In some examples, liquid crystal element 310 can include an array of transistors configured for individually addressing pixels of the liquid crystal element. Backlight 312 can be any type of light emitter including, but not limited to, one or more LEDs, one or more lamplights, one or more electroluminescent devices, and one or more fluorescent light sources. Sensors 308 can be configured to detect the presence of one or more objects and can generate a signal in response to the detected object (step 352 of process 350). Sensors 308 can be any type of sensor including, but not limited to, LIDAR, radar, and cameras. Sensors 308 can be capable of determining the location and/or velocity of the detected object(s).

In some examples, headlight 302 can be coupled to one or more processors configured for receiving the generated signal from sensors 308 (step 354 of process 350). In response to the generated signal, the one or more processors can determine the one or more adjusted signals applied to backlight 312 (step 356 of process 350), the one or more adjusted signals applied to the pair of electrodes coupled to liquid crystal element 310 (step 358 of process 350), or both. In some examples, liquid crystal element 310, backlight 312, or both can include a plurality of sections. Signals to one or more of the plurality of sections can be adjusted. In some examples, the plurality of sections can form a matrix of rows and columns. Light can exit liquid crystal element 310 with one or more intensities based on the one or more adjusted signals (step 360 of process 350). In some examples, the process can be repeated after a predetermined time interval (step 362 of process 350). In some examples, sensors 308 can be configured to continually determine whether one or more objects are present and the one or more signals applied to plurality of light emitters may not be adjusted unless sensors 308 detect a change in information. Various circumstances in which headlight 302 can be adjusted, and the manners of such adjustments, will be described in more detail later.

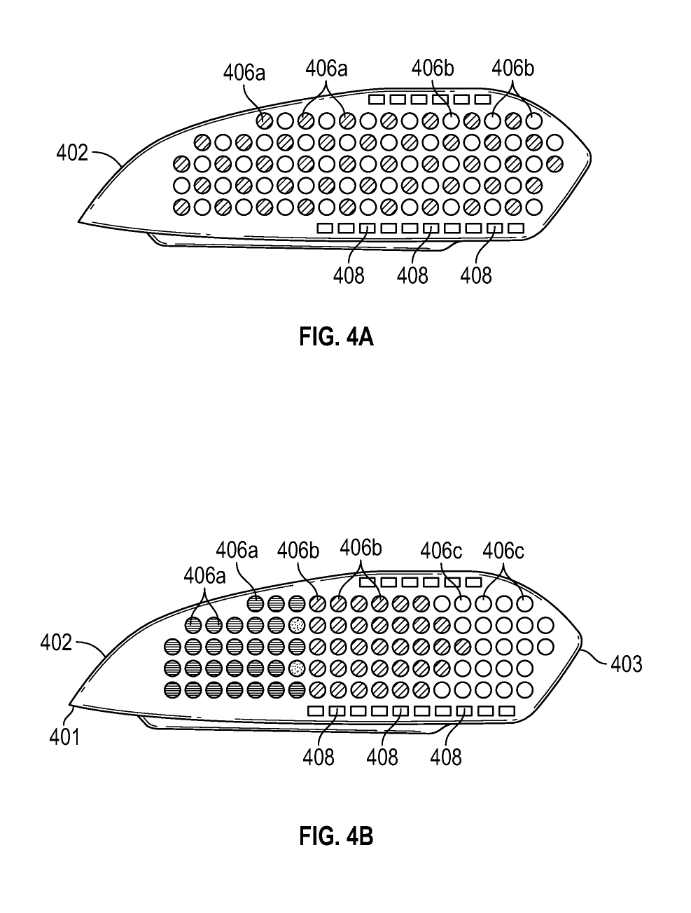

In some examples, the intensity of the light can be adjusted by activating one or more of the plurality of light emitters and deactivating others of the plurality of light emitters. FIG. 4A illustrates an exemplary headlight including a pattern of activated light emitters according to examples of the disclosure. Headlight 402 can include a plurality of light emitters 406 and sensors 408. Plurality of light emitters 406 can include plurality of light emitters 406a and plurality of light emitters 406b. Plurality of light emitters 406a can be activated (i.e., turned on), while plurality of light emitters 406b can be deactivated (i.e., turned off). In this manner, the overall intensity of light emitted from headlight 402 can be lower. In some examples, the plurality of light emitters that are activated and the plurality of light emitters that are deactivated can form a checkerboard pattern.

In some examples, the plurality of light emitters or liquid crystal element can form any type of pattern. For example, one or more sections can be dimmed, while one or more sections can be illuminated. FIG. 4B illustrates an exemplary headlight including a pattern of light emission according to examples of the disclosure. Sensors 408 can detect the presence of one or more objects located closer to one side of headlight 402, for example. Plurality of emitters 406 can form one or more patterns of light emission based on the detected object (e.g., to further illuminate the object, or to reduce the light generated by headlight 402 in the direction of the object). Headlight 402 can include a first side 401 and a second side 403. For example, processor may want to illuminate the object, which may be located closer to side 403 (than side 401). For selective illumination, plurality of light emitters 406c can be configured with a first intensity, greater than plurality of light emitters 406a and plurality of light emitters 406b. In some examples, headlight 402 can include a gradient of light intensities, where plurality of light emitters 406a can have a first intensity, plurality of light emitters 406b can have a second intensity, and plurality of light emitters 406c can have a third intensity. In some examples, the first intensity can be higher than the second intensity, and the second intensity can be higher than the third intensity. In some examples, the first intensity and the third intensity can be higher than the second intensity.

Although FIGS. 4A-4B are discussed in the context of a plurality of light emitters, examples of the disclosure can include generating a plurality of intensities and/or forming one or more patterns using a liquid crystal element. The liquid crystal element can be coupled to a transistor layer or a switching matrix, for example. The transistor layer can allow independent control of one or more sections of the headlight. Independent control can include but is not limited to, setting one or more intensities, setting one or more duty cycles (i.e., PWM), and setting one or more emission wavelengths.

In some examples, the sensors can be configured to detect one or more objects and can reconfigure the headlight pattern and/or one or more light intensities to notify or warn the object of the approaching vehicle. In some examples, the headlights can be configured to provide the warning in one or more areas/sections, while continuing normal operation in other areas/sections. For example, the headlights can be configured with low (or mid) intensity light in areas where the oncoming car is located to prevent glare, but high intensity light in other areas to direct the oncoming car to an alternative route. In some examples, the headlights can be configured to emit high intensity light at one or more objects, such as a deer, to alert the object of the vehicle's presence (or to alert the driver of the object's presence), but low (or mid) intensity light in other areas to ensure the driver has good visibility. In some examples, notifying or warning the object can include an audible alert (e.g., activating the vehicle's horn). In some examples, the sensors can be configured to detect one or more objects and can reconfigure the head beam pattern and/or one or more light intensities to prevent a sudden shock to the object (e.g., pedestrian or deer). For example, the headlight can be configured with a gradient intensity pattern (e.g., high intensity light towards the center of the vehicle and low intensity light towards the sides of the vehicle) such that the object can realize that the vehicle is approaching (with the high intensity light), while also being able to discern the shape and location of the body of the vehicle (with the low intensity light). In some examples, the sensors can be configured to detect one or more sections of poor visibility (e.g., brightness lower than a brightness threshold in one or more sections of the vehicle's surroundings) and can reconfigure the headlight pattern and/or one or more light intensities to enhance the user's visibility of those one or more sections (e.g., the headlights can be configured to increase the illumination of those one or more sections).

In some examples, the sensors can be configured to detect the reflections of a vehicle's own light emission from the headlight. The headlights can reconfigure the head beam pattern and/or one or more light intensities to reduce the intensity of emitted light by one or more sections of the headlight that are causing the reflections, to prevent obstruction of the driver's view by reflections of its own vehicle's headlights. For example, a vehicle's headlights may be reflecting off a metal building. The reflections of the vehicle's headlights may be sensed by the sensors. The headlights may then reduce the intensity of one or more sensors and/or change one or more patterns of the headlights.

In some examples, the one or more sections of the headlight can dynamically alter the wavelengths (e.g., colors) of light generated by those sections. For example, the headlight can be divided into a plurality of sections, such that each section can emit independent wavelengths (e.g., colors) of light, whether the same or different from other sections. For example, human eyes can be more sensitive to yellow light. Thus, the plurality of light emitters that are located closer to the driver's side of the oncoming car can be configured to emit yellow light and illuminate the oncoming car with the yellow light to draw the driver's attention to the oncoming car. Other sections of the headlight can continue to emit white (or near white) light. In some examples, colors of light emitted in one or more sections can be based on visibility. In some examples, colors of light emitted in one or more sections can be based on warning or alerting one or more objects (e.g., red light in areas where the object is located). In some examples, colors of light emitted in one or more sections can be used for steering (e.g., red light in areas of the road that the driver should avoid, such as a patch of ice, and green light in other areas of the road).

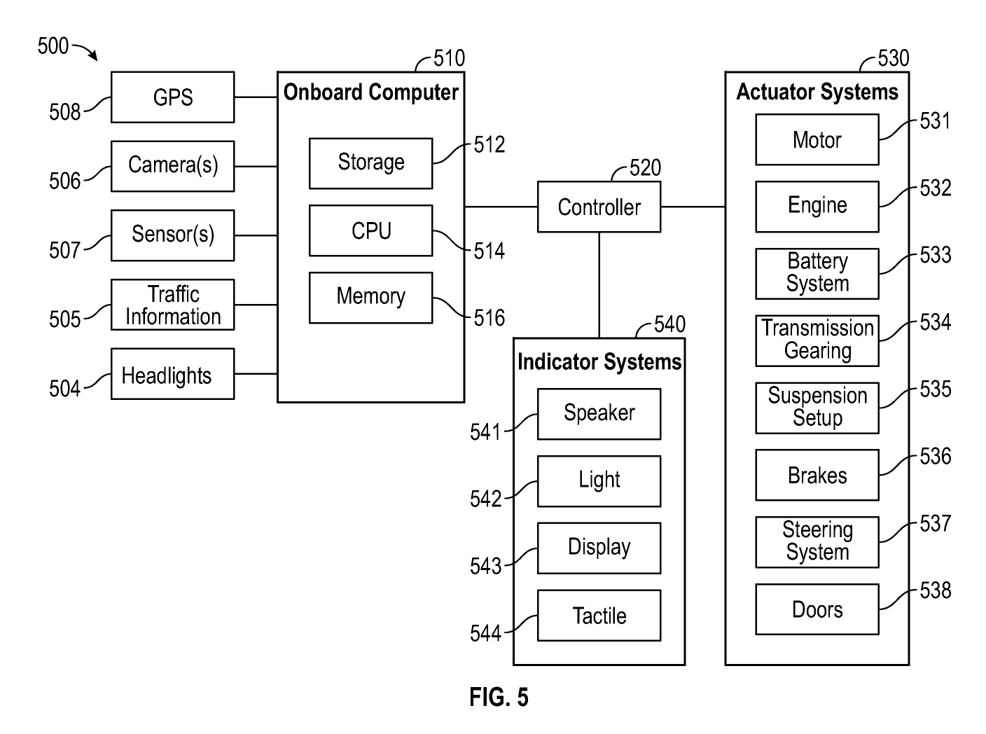

FIG. 5 illustrates an exemplary system block diagram of a vehicle control system according to examples of the disclosure. Vehicle control system 500 can perform any of the methods described with reference to FIGS. 1-4. System 500 can be incorporated into a vehicle, such as a consumer automobile. Other example vehicles that may incorporate the system 500 include, without limitation, airplanes, boats, motorcycles or industrial automobiles. Vehicle control system 500 can include one or more cameras 506 capable of capturing image data (e.g., video data) for determining various characteristics of the vehicle's surroundings. Vehicle control system 500 can also include one or more other sensors 507 (e.g., radar, ultrasonic, LIDAR, etc.) capable of detecting various characteristics of the vehicle's surroundings. For example, sensors 507 can be used for detecting the presence of one or more objects. Global Positioning System (GPS) receiver 508 can be capable of determining the location of the vehicle. Headlights 504 can include one or more of the above disclosed features.

Vehicle control system 500 can include an on-board computer 510 that is coupled to the cameras 506, sensors 507, GPS receiver 508, and headlights 504, and that is capable of receiving the image data from the cameras and/or outputs from the sensors 507, the GPS receiver 508 and the headlights 504. The on-board computer 510 can be capable of controlling operation and/or programming the headlights 504 as described in this disclosure. On-board computer 510 can include storage 512, memory 516, and a processor 514. Processor 514 can perform any of the methods described in this disclosure, including those described with reference to FIGS. 1-4. Additionally, storage 512 and/or memory 516 can store data and instructions (such as settings for operating or programming headlights 504) for performing any of the methods described in this disclosure, including those described with reference to FIGS. 1-4. Storage 512 and/or memory 516 can be any non-transitory computer readable storage medium, such as a solid-state drive or a hard disk drive, among other possibilities. The vehicle control system 500 can also include a controller 520 capable of controlling one or more aspects of vehicle operation.

In some examples, the vehicle control system 500 can be connected to (e.g., via controller 520) one or more actuator systems 530 in the vehicle and one or more indicator systems 540 in the vehicle. The one or more actuator systems 530 can include, but are not limited to, a motor 531 or engine 532, battery system 533, transmission gearing 534, suspension setup 535, brakes 536, steering system 537 and door system 538. The vehicle control system 500 can control, via controller 520, one or more of these actuator systems 530 during vehicle operation; for example, to open or close one or more of the doors of the vehicle using the door actuator system 538, to control the vehicle during autonomous driving or parking operations using the motor 531 or engine 532, battery system 533, transmission gearing 534, suspension setup 535, brakes 536 and/or steering system 537, etc. The one or more indicator systems 540 can include, but are not limited to, one or more speakers 541 in the vehicle (e.g., as part of an entertainment system in the vehicle), one or more lights 542 in the vehicle, one or more displays 543 in the vehicle (e.g., as part of a control or entertainment system in the vehicle) and one or more tactile actuators 544 in the vehicle (e.g., as part of a steering wheel or seat in the vehicle). The vehicle control system 500 can control, via controller 520, one or more of these indicator systems 540 to provide indications to a user of the vehicle of the operation or programming of headlights 504 controlled by the on-board computer 510 (e.g., to alert the user that programming of the headlights is complete).

A system is disclosed. The system can comprise: a plurality of light emitters included in a headlight of a vehicle, the plurality of light emitters configured for emitting light, wherein each light emitter is capable of being independently controlled; one or more sensors configured for detecting a condition in the vehicle's surroundings; and a processor coupled to the plurality of light emitters and the one or more light sensors, the processor configured to: transmit one or more first signals to the plurality of light emitters, the one or more first signals associated with one or more intensities of the plurality of light emitters, receive one or more second signals from the one or more sensors, the one or more second signals including information associated with detected location, velocity, or both, and dynamically adjust the one or more intensities and the one or more first signals based on the one or more second signals. Additionally or alternatively, in some examples, the plurality of light emitters comprises an array of light emitting diodes (LEDs). Additionally or alternatively, in some examples, the one or more sensors are included in the headlight. Additionally or alternatively, in some examples, the one or more sensors are included in a component external to the headlight. Additionally or alternatively, in some examples, the plurality of light emitters include a plurality of first light emitters and a plurality of second light emitters, the plurality of first light emitters interleaved with the plurality of second light emitters, wherein the processor is further configured to: activate the plurality of first light emitters, and deactivate the plurality of second light emitters. Additionally or alternatively, in some examples, the plurality of first light emitters interleaved with the plurality of second light emitters forms a checkerboard pattern. Additionally or alternatively, in some examples, the plurality of first light emitters emits white or near white light and at least one of the plurality of emitters emits yellow light. Additionally or alternatively, in some examples, dynamically adjusting the one or more intensities includes gradually increasing the intensity as the one or more sensors detects another vehicle approaching. Additionally or alternatively, in some examples, dynamically adjusting the one or more intensities includes creating a gradient intensity pattern in response to a presence of an object, the gradient intensity pattern including high intensity light emitted towards locations of the object and low intensity light emitted in other locations.

A system is disclosed. The system can comprise: a backlight included in a headlight of a vehicle, the backlight configured to emit light; a liquid crystal element included in the headlight, coupled to a plurality of electrodes, and configured to allow light emitted from the backlight to transmit through, wherein an amount of light allowed to transmit through is based on a voltage difference applied to the plurality of electrodes; one or more sensors configured to detect a condition in the vehicle's surroundings; and a processor coupled to the backlight, the liquid crystal element, and the one or more sensors, the processor configured to: transmit one or more first signals to the backlight, the liquid crystal element, or both, the one or more first signals associated with one or more intensities of light emitted by the system, receive one or more second signals from the one or more sensors, the one or more second signals including information associated with detected location, velocity, or both, and dynamically adjust the one or more first signals based on the one or more second signals. Additionally or alternatively, in some examples, the one or more sensors are included in the headlight. Additionally or alternatively, in some examples, the one or more first signals are transmitted to the backlight and include one or more currents to control an intensity of light emitted by the backlight. Additionally or alternatively, in some examples, the one or more first signals are transmitted to the plurality of electrodes included in the liquid crystal element and include one or more voltage values to control an intensity of light allowed to transmit through the liquid crystal element.

A method is disclosed. The method can comprise: applying one or more currents or voltages to one or more optical elements, the one or more currents or voltages associated with one or more intensities of light emitted by a headlight included in a vehicle, detecting information using one or more sensors, the information associated with a detected condition in the vehicle's surroundings, and dynamically adjust the one or more currents or voltages based on the one or more second signals. Additionally or alternatively, in some examples, the condition includes a presence of a nearby object based on a contrast or infrared emissions. Additionally or alternatively, in some examples, applying the one or more currents or voltages to the one or more optical elements includes applying the one or more currents to a plurality of light emitting diodes (LEDs) or one or more sections of a backlight or one or more voltages to a plurality of electrodes included in a liquid crystal element. Additionally or alternatively, in some examples, applying one or more currents or voltages to the one or more optical elements includes: applying one or more first currents or voltages to a first one or more optical elements, and applying one or more second currents or voltages to a second one or more optical elements, the one or more second currents or voltages different than the one or more first currents or voltages. Additionally or alternatively, in some examples, applying one or more currents or voltages to the one or more optical elements includes: modulating the one or more currents at a duty cycle, the duty cycle associated with the intensities of light emitted by the headlight. Additionally or alternatively, in some examples, the method further comprises: activating a horn in response to the detected condition, wherein the detected condition includes a presence of a nearby object. Additionally or alternatively, in some examples, the detected condition includes a visibility, the method further comprises: determining whether the visibility is less than a pre-determined threshold, wherein dynamically adjusting the one or more currents or voltages is further based on the visibility.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
a plurality of light emitters included in a headlight of a vehicle, the plurality of light emitters configured for emitting light, wherein each light emitter is capable of being independently controlled;
one or more sensors configured for detecting a condition in the vehicle's surroundings; and
a processor coupled to the plurality of light emitters and the one or more sensors, the processor configured to:
transmit one or more first signals to the plurality of light emitters, the one or more first signals associated with one or more intensities of the plurality of light emitters,
receive one or more second signals from the one or more sensors, the one or more second signals including information associated with detected location, velocity, or both, and
dynamically adjust the one or more intensities and the one or more first signals based on the one or more second signals.

2. The system of claim 1, wherein the plurality of light emitters comprises an array of light emitting diodes (LEDs).

3. The system of claim 1, wherein the one or more sensors are included in the headlight.

4. The system of claim 1, wherein the plurality of light emitters include a plurality of first light emitters and a plurality of second light emitters, the plurality of first light emitters interleaved with the plurality of second light emitters,
wherein the processor is further configured to:
activate the plurality of first light emitters, and
deactivate the plurality of second light emitters.

5. The system of claim 4, wherein the plurality of first light emitters interleaved with the plurality of second light emitters forms a checkerboard pattern.

6. The system of claim 1, wherein at least one of the plurality of emitters emits white or near white light and at least one of the plurality of emitters emits yellow light.

7. The system of claim 1, wherein dynamically adjusting the one or more intensities includes gradually increasing the intensity as the one or more sensors detects another vehicle approaching.

8. The system of claim 1, wherein dynamically adjusting the one or more intensities includes creating a gradient intensity pattern in response to a presence of an object, the gradient intensity pattern including high intensity light emitted towards locations of the object and low intensity light emitted in other locations.

9. A system comprising:
a backlight included in a headlight of a vehicle, the backlight configured to emit light;
a liquid crystal element included in the headlight, coupled to a plurality of electrodes, and configured to allow light emitted from the backlight to transmit through, wherein an amount of light allowed to transmit through is based on a voltage difference applied to the plurality of electrodes;
one or more sensors configured to detect a condition in the vehicle's surroundings; and
a processor coupled to the backlight, the liquid crystal element, and the one or more sensors, the processor configured to:
transmit one or more first signals to the backlight, the liquid crystal element, or both, the one or more first signals associated with one or more intensities of light emitted by the system,
receive one or more second signals from the one or more sensors, the one or more second signals including information associated with detected location, velocity, or both, and
dynamically adjust the one or more first signals based on the one or more second signals.

10. The system of claim 9, wherein the one or more sensors are included in the headlight.

11. The system of claim 9, wherein the one or more first signals are transmitted to the backlight and include one or more currents to control an intensity of light emitted by the backlight.

12. The system of claim 9, wherein the one or more first signals are transmitted to the plurality of electrodes included in the liquid crystal element and include one or more voltage values to control an intensity of light allowed to transmit through the liquid crystal element.

13. A method comprising:
applying one or more currents or voltages to one or more optical elements, the one or more currents or voltages associated with one or more intensities of light emitted by a headlight included in a vehicle,
detecting information using one or more sensors, the information associated with a detected condition in the vehicle's surroundings, and
dynamically adjust the one or more currents or voltages based on the one or more intensities and the one or more second signals.

14. The method of claim 13, wherein the condition includes a presence of a nearby object based on a contrast or infrared emissions.

15. The method of claim 13, wherein applying the one or more currents or voltages to the one or more optical elements includes applying the one or more currents to a plurality of light emitting diodes (LEDs) or one or more sections of a backlight or applying one or more voltages to a plurality of electrodes included in a liquid crystal element.

16. The method of claim 13, wherein applying one or more currents or voltages to the one or more optical elements includes:
applying one or more first currents or voltages to a first one or more optical elements, and
applying one or more second currents or voltages to a second one or more optical elements, the one or more second currents or voltages different than the one or more first currents or voltages.

17. The method of claim 13, wherein applying one or more currents or voltages to the one or more optical elements includes:
modulating the one or more currents at a duty cycle, the duty cycle associated with the intensities of light emitted by the headlight.

18. The method of claim 13, further comprising:
activating a horn in response to the detected condition, wherein the detected condition includes a presence of a nearby object.

19. The method of claim 13, wherein the detected condition includes a visibility, the method further comprising:
determining whether the visibility is less than a pre-determined threshold, wherein dynamically adjusting the one or more currents or voltages is further based on the visibility.
